(19) United States
(12) Patent Application Publication
(10) Pub. No.: US 2023/0244711 A1
(43) Pub. Date: Aug. 3, 2023

(54) SYSTEMS AND METHODS PROCESSING DIGITAL IMAGES

(71) Applicant: MemoryWeb, LLC, Glen Ellyn, IL (US)

(72) Inventors: Christopher J. Desmond, Glen Ellyn, IL (US); Nancy L. Desmond, Glen Ellyn, IL (US); L. Michael Taylor, Chicago, IL (US)

(21) Appl. No.: 18/093,446

(22) Filed: Jan. 5, 2023

Related U.S. Application Data
(60) Provisional application No. 63/299,565, filed on Jan. 14, 2022.

(51) Int. Cl. G06F 16/532; G06F 16/16; G06F 3/04847

(52) U.S. Cl. CPC G06F 16/532; G06F 3/04847; G06F 16/162

(57) ABSTRACT

In some embodiments, apparatuses and methods are provided herein useful to processing digital images. In some embodiments, a system for processing digital images comprises a database configured to store a plurality of digital images and a control system configured to determine that a subset of the plurality of digital images are corresponding images, generate a user interface including at least a portion of one or more of the corresponding images, receive a selection associated with one of the corresponding images, cause data associated with one or more of the corresponding images to be presented, receive a selection of at least a portion of the data associated with one or more of the corresponding images, and merge the at least a portion of the data associated with one or more of the corresponding images with data associated with the one of the corresponding images.

### TECHNICAL FIELD

This invention relates generally to the digital files and, more specifically, the management of digital files.

### BACKGROUND

As the number of devices with cameras increases and the cost of storage mediums decreases, users are generating an ever-increasing amount of digital content (e.g., images and videos). In fact, many users have generated, and now possess, such a large volume of digital content that it can be difficult, if not impossible, to efficiently organize the digital content. One problem faced is the ubiquity of duplicate files (e.g., the same or similar photographs) within a user’s library of digital content. Not only do duplicate files take up additional storage space, but duplicate files increase the clutter and difficulty of organizing digital content. While systems exist that can identify duplicate files, they provide little, if any, capability for intelligently managing the duplicate files. Accordingly, a need exists for system and methods that can more intelligently and effectively manage duplicate files in a user’s library.

### BRIEF DESCRIPTION OF THE DRAWINGS

Disclosed herein are embodiments of systems, apparatuses, and methods pertaining to processing digital images. This description includes drawings, wherein:

FIG. 1 depicts a user interface 100 allowing a user to locate corresponding images, according to some embodiments;

FIG. 2 depicts a user interface 200 in which a user has decreased a threshold level for locating corresponding images, according to some embodiments;

FIG. 3 depicts a user interface 300 depicting groups of corresponding images, according to some embodiments;

FIG. 4 depicts a user interface 400 after selection of one of the groups of corresponding images, according to some embodiments;

FIG. 5 depicts a user interface 500 after selection of a tile from one of the groups of corresponding images, according to some embodiments;

FIG. 6 depicts a user interface 600 in which a user can modify data for association with one of the corresponding images, according to some embodiments;

FIG. 7 depicts a user interface 700 presenting data to be associated with one of the corresponding images, according to some embodiments;

FIG. 8 depicts a user interface 800 in which a user can review data to be merged and associated with a corresponding image, according to some embodiments;

FIG. 9 depicts a user interface 900 in which a user can confirm merging of data associated with corresponding images, according to some embodiments;

FIG. 10 is a flow chart depicting example operations for processing digital images, according to some embodiments;

FIG. 11 is a block diagram of a system 1100 for processing digital images, according to some embodiments; and

FIG. 12 is a block diagram of a system 1200 that may be used for implementing any of the components, circuits, circuitry, systems, functionality, apparatuses, processes, or devices of the system 1100 of FIG. 11, and/or other above or below mentioned systems or devices, or parts of such circuits, circuitry, functionality, systems, apparatuses, processes, or devices, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

Generally speaking, pursuant to various embodiments, systems, apparatuses, and methods are provided herein useful to processing digital images. In some embodiments, a system for processing digital images comprises a database configured to store a plurality of digital images and a control system configured to determine, using a matching algorithm, that a subset of the plurality of digital images are corresponding images, generate a user interface including at least a portion of one or more of the corresponding images, receive, from a user via the user interface, a selection associated with one of the corresponding images, cause data associated with one or more of the corresponding images to be presented via the user interface, receive, from the user via the user interface, a selection of at least a portion of the data associated with one or more of the corresponding images, and responsive to the selection of at least a portion of the data associated with one or more of the corresponding images, merge the at least a portion of the data associated with one or more of the corresponding images with data associated with the one of the corresponding images.

As previously discussed, users of devices are generating digital content at a seemingly ever-increasing rate. Such generation of digital content makes it difficult, if not impossible, for users to efficiently organize their digital content. One specific issue faced is that of duplicate files (i.e., multiple files having content that is, or is nearly, the same). These duplicate files add digital clutter and make it difficult for users to efficiently organize their digital content, and in some cases, find the digital content they are looking for. While these files may be duplicates in the sense that they include the same primary content (e.g., an image, video, document, audio recording, etc.), they may not be identical to one another. Digital files often include data associated with the digital file. This data can include captions, dates, file names, locations, people, albums, keywords, etc. Accordingly, while each of the duplicate files may include the same primary content, they may not all include the same associated data. For example, assume that two digital images, Photo₁ and Photo₂, are duplicates. Photo₁ and Photo₂ are duplicates in that they are the same photograph (i.e., photographs of the same scene), however the data associated with each of the digital images is not identical. For example, assume that Photo₁ includes a location tag (e.g., data associated with the photograph indicative of a location at which the photograph was taken) and Photo₂ includes a date tag (e.g., data associated with a date upon which the photograph was taken).

While systems exist that can identify duplicate files, they provide little, if any, capability for intelligently managing the duplicate files. For example, the user may wish to delete all but one of the duplicate files to reduce clutter. However, doing so may result in the loss of data associated with those duplicate files that are deleted. Continuing the example above, if the user deletes Photo₁, they will lose the location information associated with Photo₁. However, if the user deletes Photo₂, they will lose the date information associated with Photo₂. Unfortunately, the ability of current systems to simply identify duplicate files does not allow the user to intelligently manage their digital content.

Some of the systems that are capable of identifying duplicate files handle data associated with the files by automatically deleting, merging, replacing, etc. the data associated with the duplicate files. Returning to the example above with Photo₁ and Photo₂, existing systems that identify these two photos as duplicates may use a rule-based system to determine whether to keep the data associated with Photo₁, the data associated with Photo₂, or some combination of the data associated with both Photo₁ and Photo₂. This approach, however, also has significant drawbacks. For example, if both Photo₁ and Photo₂ include associated data related to a date associated with the files, the system will select which of the two dates to keep. If one of the dates is that date that the photo was taken and the second date is a date that the photo was duplicated, the first date may be more valuable to the user. However, if the system follows a rules-based approach in which the data from the most recent file is kept, the first date (i.e., the date upon which the photo was taken) will be lost. Accordingly, the automatic selection of data to keep from duplicate files does not ensure that the most relevant, or important, data is kept.

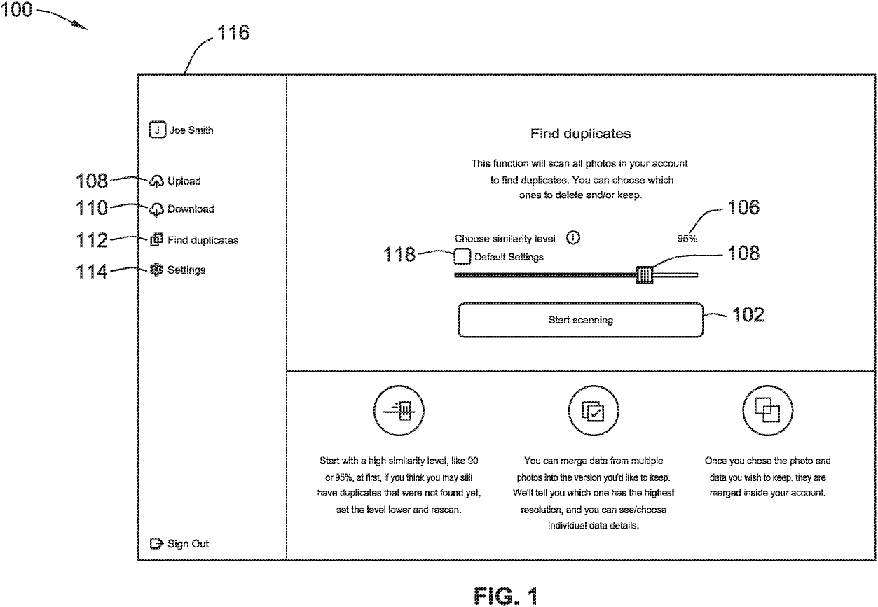

Described herein are systems, methods, and apparatuses that seek to minimize, if not eliminate, the drawbacks of the currently available systems. In one embodiment, a system identifies corresponding images (e.g., multiple files that include the same primary content and/or multiple files that include similar primary content) and allows a user to select data from the corresponding images to merge into one of the corresponding images. Continuing the example above, the user could choose to merge the location tag from Photo₁ into the data file associated with Photo₂ such that Photo₂ includes both the location tag and the date tag. In this manner, the user is able to select what associated data they would like to keep. The user would then be able to remove Photo₁ while still maintaining the data associated with Photo₁ as data associated with Photo₂. Further, in some embodiments, the system may allow the user to select, and retain, more than one set of associated data for a file. For example, the user may be able to select associated data from multiple corresponding files to associate with a single file. The discussion of FIGS. 1 - 9 provide an overview of such a process. Though the discussion of FIGS. 1 - 9 is organized as a step-by-step progression through a user interface for processing digital images, it should be noted that user interfaces depicted are simply examples and that additional, fewer, or otherwise different user interface presentations are contemplated.

FIG. 1 depicts a user interface 100 allowing a user to locate corresponding images, according to some embodiments. The corresponding images are those images that have the same, or similar, primary content. For example, two images may be corresponding images if they are identical images (e.g., copies of the same image imported from different sources), images created within a certain time of one another (e.g., images in a series of images taken in quick succession), images that contain a certain portion of matching features, etc. The data files include data in addition to the images. That is, the data files include data associated with the digital images. The data associated with the digital images can include captions, dates, file names, locations, people, albums, keywords, etc. The data associated with the digital images may not be the same for each of the corresponding images. Accordingly, though the images are corresponding images, the data files may not correspond with one another.

The user interface 100 allows the user to locate corresponding images from a plurality of images. The user interface 100 includes a control panel 116. The control panel 116 includes a number of selections. For example, as depicted in FIG. 1, the control panel 116 incudes an upload selection 108, a download selection 110, a find duplicates selection 112, and a settings selection 114. The upload selection 108 allows the user to upload images (or other digital content) to a database. For example, in some embodiments, the digital images are stored remotely (e.g., in a remote storage device, such as a database) from the user device (e.g., the device with which the digital images were taken). In such embodiments, the user can upload the digital images from the user device to the database. It should be noted that the user may be able to upload digital images from any suitable user device (e.g., a desktop computer, laptop computer, tablet, etc.). The download selection 110 allows the user to download images (or other digital content) from the database. In embodiments in which the digital images are stored remotely, the user can download the digital images from the database to the user device. In some embodiments, if the user has merged data from one of the digital images with a second digital image, when the user downloads the second digital image, the second digital image including the merged content is downloaded. The find duplicate selection 112 allows the user to locate corresponding images (or other digital content). The settings selection 112 allows the user to access a settings menu.

As depicted in FIG. 1, the user has selected the find duplicates selection 112. Accordingly, the user interface 100 is presenting a find duplicates prompt. The find duplicates prompt allows the user to adjust a sensitivity of the duplicate finder functionality via a sensitivity selection 104. Though depicted as a slider in FIG. 1, the sensitivity selection 104 can take any suitable form (e.g., an entry field, radio selections, drop down menu, etc.). As depicted in FIG. 1, the user has adjusted the sensitivity selection 104 such that images will be considered corresponding images if they match a 95% threshold, as indicated by the similarity level indicator 106. The find duplicates prompt includes a start selection 102. Selection of the start selection 102 causes the duplicate finder to locate corresponding images.

In some embodiments, the user interface 100 includes a default settings selection 118. The default settings selection 118 bases the corresponding image search on one or more of the values at a default level. For example, selection of the default settings selection 118 can adjust the threshold to a default threshold (e.g., 50%). Additionally, or alternatively, the default threshold can be a dynamic value that is altered automatically during the search for corresponding images. For example, the search can progress with a high threshold (e.g., 90%) and if no, or few, corresponding images are located, the threshold can be automatically lowered.

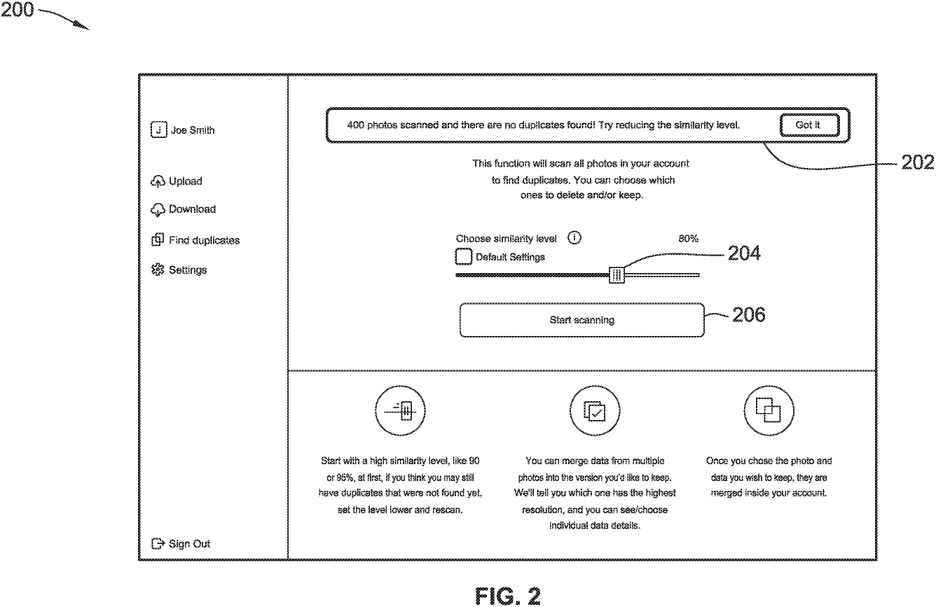

FIG. 2 depicts a user interface 200 in which a user has decreased a threshold level for locating corresponding images, according to some embodiments. As depicted in FIG. 2, no corresponding images were found based on the 95% threshold selected by the user in FIG. 1, as indicated by the no duplicates found prompt 202. Accordingly, as depicted in FIG. 2, the user has decreased the sensitivity of the duplicate finder via a sensitivity selection 204 to 80%. Upon selection of a start selection 206, the duplicate finder scans the images to locate corresponding images based on the 80% threshold. The corresponding images are a subset of the images that the duplicate finder analyzed.

Although the discussion of FIGS. 1 and 2 describes identifying corresponding images in response to a user request to find duplicates, embodiments are not so limited. That is, in some embodiments, the duplicate finder can identify corresponding images without explicit user input to do so. For example, when a user uploads an image, saves an image, captures an image, receives an image, selects an image to view, etc., the duplicate finder can perform a search to identify if the current image corresponds to any other images. Such identification can be limited to the current image. For example, if the user receives an image via a multimedia messaging service (MMS) message and saves the image, the duplicate finder can identify corresponding images, if any, for the image that the user is currently saving. At that time, the user can control the data associated with the corresponding images as discussed herein.

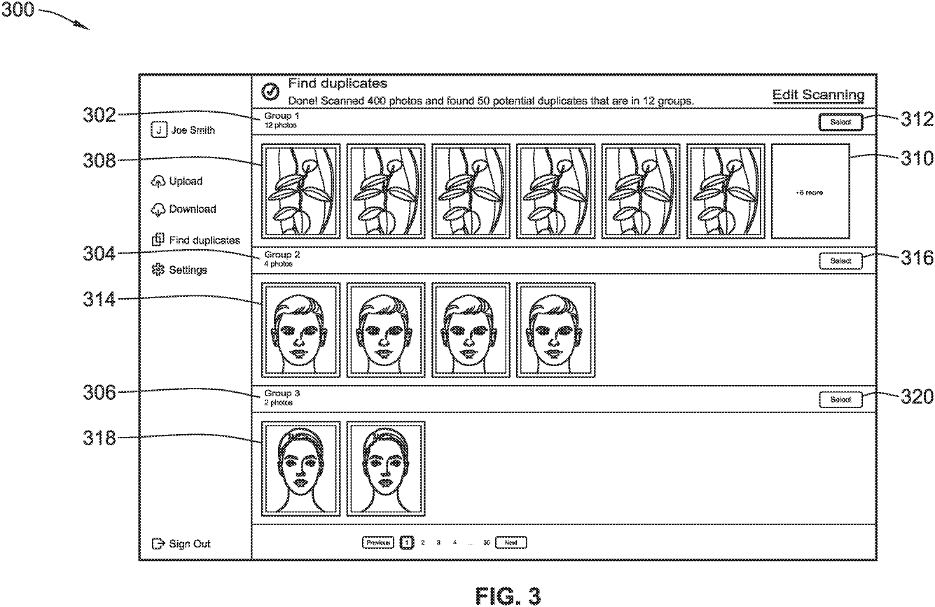

FIG. 3 depicts a user interface 300 depicting groups of corresponding images, according to some embodiments. Based on the decreased sensitivity, the duplicate finder located a number of corresponding images. As depicted in FIG. 3, the duplicate finder located three groups of corresponding images: a first group 302; a second group 304; and a third group 306. Each of the groups includes corresponding images. For example, each image 308 in the first group 302 corresponds to the other images 308 in the first group 302, each image 314 in the second group 304 corresponds to the other images 314 in the second group 304, and each image 318 in the third group 306 corresponds to the other images 318 in the third group 306. In some embodiments, and as depicted in FIG. 3, the user interface 300 includes an indication of the number of images in each group and a selection of each of the groups (i.e., a first group selection 312, a second group selection 316, and a third group selection 320).

The user interface 300 include at least a portion of one or more of the images in each group. For example, as depicted in FIG. 3, the user interface 300 includes each of the four images 314 of the second group. In some embodiments, the user interface 300 may not depict every image in each of the groups. For example, as depicted in FIG. 3, the first group 302 includes 12 images 308 but only portions of six of the images 308 are included in the user interface 300. Additionally, the user interface 300 includes an additional images icon 310. The additional images icon 310 indicates that the first group 302 includes additional corresponding images, portions of which are not included in the user interface 300. The user can select one of the group selections to view the images in the group.

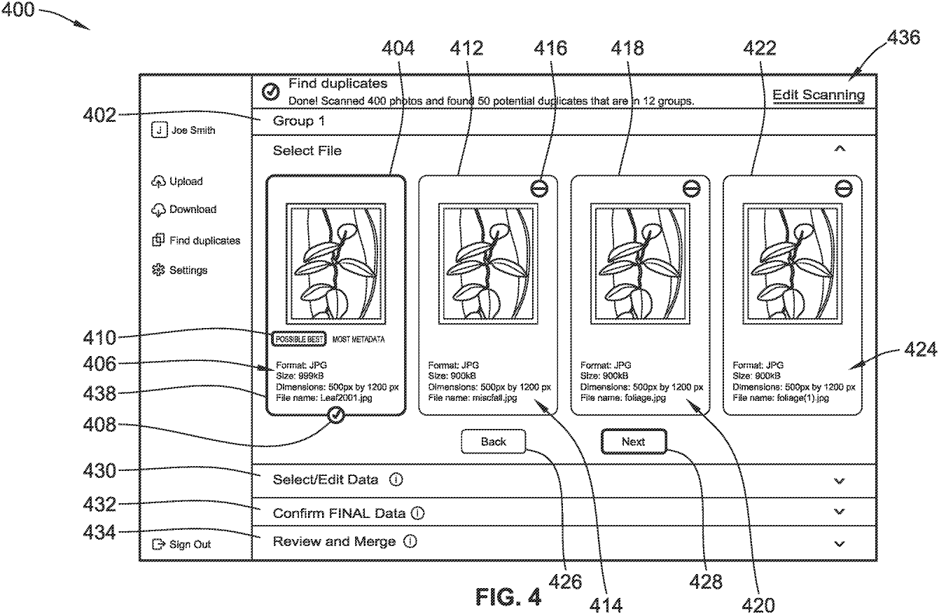

FIG. 4 depicts a user interface 400 after selection of one of the groups of corresponding images, according to some embodiments. As depicted in FIG. 4, and indicated by a group identifier 402, the user has selected the first group from FIG. 3. The user interface 400 includes tiles for each of the corresponding images. Each tile includes a representation of one of the corresponding images (e.g., the corresponding image, a portion of the corresponding image, a thumbnail of the corresponding image, etc.). Specifically, the user interface 400 includes four tiles: 1) a first tile 404; 2) a second tile 412; 3) a third tile 418; and 4) a fourth tile 422. The first tile 404 is associated with a first of the corresponding images, the second tile 412 is associated with a second of the corresponding images, the third tile 418 is associated with a third of the corresponding images, and the fourth tile 422 is associated with a fourth of the corresponding images. As noted previously, the first group includes 12 images. The user interface 400 may not include a tile for each of the corresponding images, as depicted in FIG. 4. In such embodiments, the user interface 400 can include navigation controls that allow the user to navigate through the corresponding images.

Each of the tiles includes one of the corresponding images (or a portion of one of the corresponding images) and indicia for the data associated with each of the corresponding images. As depicted in FIG. 4, the first tile 404 includes a first indicium 406, the second tile 412 includes a second indicium 414, the third tile 418 includes a third indicium 420, and the fourth tile includes a fourth indicium 424. The indicia can include any (e.g., a portion or all) of the data associated with the corresponding images. As depicted in FIG. 4, the indicia include a format (e.g., type) of file for the corresponding image, a size of the file for the corresponding image, dimensions of the corresponding image, and a file name for the file associated with the corresponding image. For example, the first indicium 406 informs the user that the file associated with the corresponding image of the first tile 404 is a JPEG that is 999 kb in size, the corresponding image of the first tile 404 has dimensions of 500 pixels by 1,200 pixels, and the file name of the file associated with the first corresponding image of the first tile 404 is “Leaf2001.”

In some embodiments, the user interface 400 includes recommendations and/or comments associated with the files and/or corresponding images. For example, as depicted in FIG. 4, the user interface 400 is annotated to include annotations 410 that the corresponding image associated with the first tile 404 is a possible best of the corresponding images and has the most data of the corresponding images. The user can use this information to aid the user in selected one of the corresponding images. As depicted in FIG. 4, and indicated by a marker 408 and bolding 438 of the border of the first tile 404, the corresponding image associated with the first tile 404 has been selected. In one embodiment, the selection of the first tile 404 (i.e., the corresponding image associated with the first tile 404) can be performed manually by the user. That is, after reviewing the corresponding images, the data associated with the corresponding images, and the recommendations and/or comments (if any), the user can select the corresponding image. Additionally, or alternatively, the system can select the corresponding image for the user or recommend one or more of the corresponding images for selection by the user. In some embodiments, when a user selects a new one of the corresponding images, the currently selected corresponding image becomes unselected automatically.

In some embodiments, the tiles include selections associated with the tiles. For example, one or more of the tiles can include a removal selection 416. The removal selection 416 removes the associated tile from the user interface 400. For example, selection of the removal selection 416 associated with the second tile 412 removes the second tile 412 from the user interface 400. As one example, if one of the images indicated as a corresponding image is not in fact a corresponding image, the user can manually remove the tile from the user interface 400. Removal of the tile from the user interface 400 can, but need not, impact the file associated with the tile of the image associated with the tile. For example, removal of the second tile 412 from the user interface can remove the file associated with the second tile 412 from an album, delete the file associated with the second tile 412 from a database, disassociate the file associated with the second tile 412 from others of the corresponding images, minimize the second tile 412 from the user interface 400, etc.

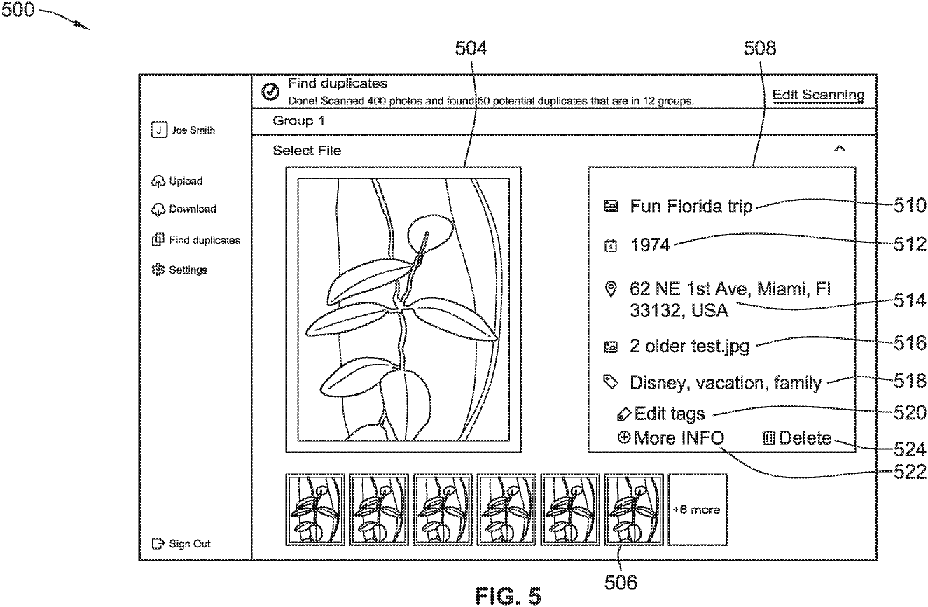

In some embodiments, the user can choose one of the corresponding images to view a larger or more detailed presentation of the tile, or information included in the tile, associated with the chosen corresponding image. A view of such a user interface 500 is depicted in FIG. 5. FIG. 5 depicts the user interface 500 after selection of a tile from one of the groups of corresponding images, according to some embodiments. As depicted in FIG. 5, the user selected the tile associated with one of the corresponding images 504. The corresponding image 504 was associated with one of the tiles from the user interface depicted in FIG. 4. Selection of the tile from the user interface of FIG. 4 causes presentation of the user interface 500 of FIG. 5. The user interface 500 includes the corresponding image 504 associated with the chosen tile and a window 508 including the data associated with the corresponding image 504.

In one embodiment, the corresponding image 504 is enlarged as compared to the depiction of the corresponding image in the tile of FIG. 4. For example, the corresponding image 504 can be enlarged, include the full corresponding image, be more detailed or higher resolution, etc. when compared to the corresponding image in the tile of FIG. 4. Similarly, the window 508 can include the same information, additional information, or more detailed information when compared with the indicia of the tiles in FIG. 4. For example, as depicted in FIG. 5, the window 508 includes an album indicator 510, a date tag 512, a location tag 514, a file name 516, and a tag indicator 518. It should be noted that each of these fields can be populated automatically and/or by the user. That is, the tags can be generated by the system and/or by the user. The album indicator 510 provides a name, if any, of the album that includes the corresponding image 504, the date tag 512 indicates a date associated with the corresponding image 504, the location tag 514 indicates a location associated with the corresponding image 504, and the tags indicator 518 include tags that are associated with the corresponding image 504. Additionally, in some embodiments, the window 508 can include controls associated with the corresponding image 504 and/or the data associated with the corresponding image. For example, the controls can include an edit tags control 520, a more information control 522, and a delete control 524. The edit tags control 520 allows the user to edit (e.g., delete, add, modify, etc.) the tags associated with the corresponding image 504, the more information control 522 causes the user interface 500 to present additional information (if any) associated with the corresponding image 504 (e.g., information not currently presented in the window 508), and the delete control 524 allows the user to remove some, or all, of the data associated with the corresponding image 504.

In some embodiments, the user interface 500 allows the user to navigate through the corresponding images of the group. For example, as depicted in FIG. 5, the user interface 500 include thumbnails associated with the corresponding images in the selected group. Selection of one of the thumbnails causes the user interface 500 to present the corresponding image associated with the selected thumbnail and a window (e.g., like the window 508) including the data associated with the corresponding image associated with the selected thumbnail.

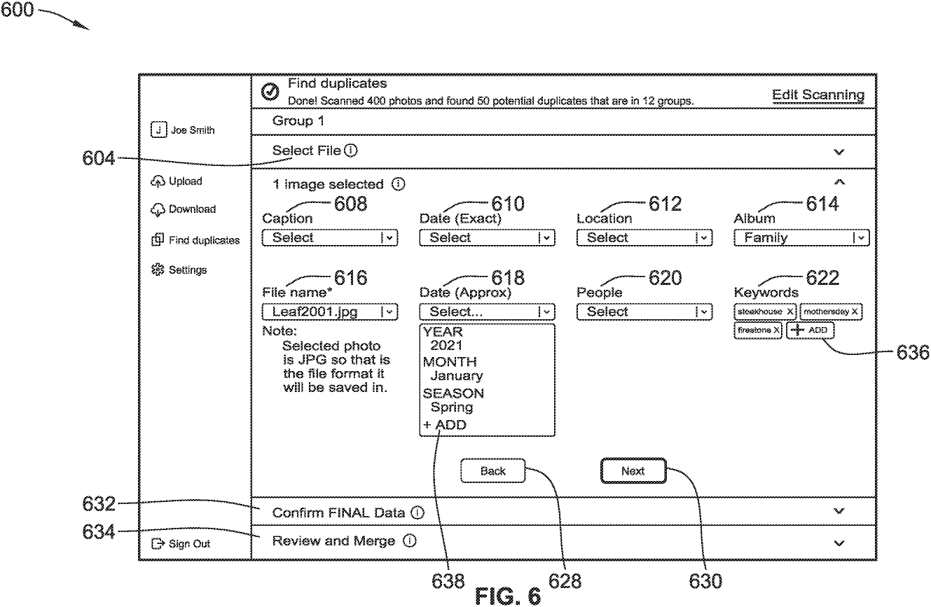

Referring back to FIG. 4, in some embodiments, the user interface 400 also includes navigational tools that allow the user to proceed through the user interface 400. As one example, the user interface 400 can include edit scanning selection 436. If the user selects the edit scanning selection 436, the user can change or modify the parameters for finding corresponding images. For example, selection of the edit scanning selection 436 can be return the user to the user interface of FIG. 2. Additionally, the user interface 400 includes a select data control 430, a confirm data control 432, and a review control 434. The user can select the control associated with the next step that they would like to take. FIG. 6 depicts a user interface after the user has selected the select data control 430. The user interface 400 can also include navigational tools that step the user to the previous or next user interface. For example, a back control 426 can cause the presentation of the user interface of FIG. 3 and the selection of a next control 428 can cause the presentation of the user interface of FIG. 6.

FIG. 6 depicts a user interface 600 in which a user can modify data for association with one of the corresponding images, according to some embodiments. In some embodiments, once one of the corresponding images has been selected (e.g., manually by the user and/or automatically for the user), the user can modify the data for association with the selected corresponding image. Returning to the example provided regarding two corresponding photos (i.e., Photo₁ and Photo₂) where Photo₁ includes a location tag and Photo₂ includes a date tag, if the user selects Photo₁ the user can modify the data associated with Photo₁ to include the date tag of Photo₂. Such manual selection of the data associated with the corresponding images prevents data that the user would like to keep from being automatically overwritten when corresponding images are not chosen. The user interface 600 of FIG. 6 allows a user to modify the data associated with the selected image in this manner.

The user interface 600 includes a variety of data fields that the user can utilize to modify the data to be associated with the selected corresponding image. In some embodiments, the data fields are prepopulated based on existing data associated with one or more of the corresponding images. That is, if any of the corresponding images include data associated with one of the data fields, that data is included in the data fields for modification by the user. As depicted in FIG. 6, the user interface includes a caption field 608, a first date field 610, a location field 612, an album field 614, a file name field 616, a second date field 618, a people field 620, and a keyword field 622. It should be noted that greater, fewer, or different data fields are contemplated and that the data fields depicted in FIG. 6 are but an example. In one embodiment, the data associated with the selected corresponding image is shown as the default data for each field. That is, the user interface includes an aggregation of all data associated with the corresponding images. For example, as shown in the album field 614, the selected corresponding image is associated with an album titled “Family,” and the name of the album appears as the default data for the album field 614.

Each of the data fields has an entry mechanism. The entry mechanism can be of any suitable type. For example, the entry mechanism can be a drop-down menu, radio buttons, a text entry field, etc. The user can modify the data associated with the corresponding images via the data fields. That is, the user interface allows the user to select the associated data for the corresponding images to merge and/or keep with the selected one of the corresponding images. The caption field 608 allows the user to select and/or enter a caption, the first date field 610 allows the user to select and/or enter a date (e.g., an exact date), the location field 612 allows the user to select and/or enter a location (e.g., an address, city, state, GPS coordinates, building name, landmark name, etc.), the album field 614 allows the user to select and/or enter an album (e.g., an album in which the corresponding image should be included), the file name field 616 allows the user select and/or enter a file name and/or file type (i.e., format), the second date field 618 allow the user to select and/or enter a date (e.g., an approximate date such as a year, season, month, etc.), the people field 620 allows the user to select and/or enter indicia of people (e.g., names of people appearing in the corresponding images, familial and/or social relationships of people appearing in the corresponding image, etc.), and the keyword field 622 allows to the user to select and/or enter keywords. In some embodiments, the user interface 600 includes selections to add data. For example, an add date selection 638 allows a user to add a date that is not prepopulated and a plus icon 636 allows a user to add additional keywords.

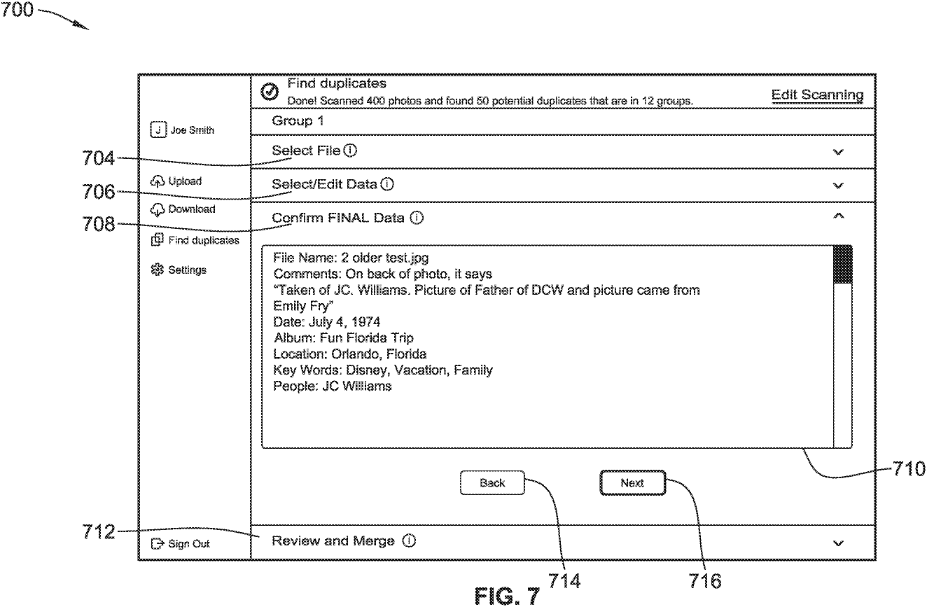

The user interface 600 includes navigational tools. The navigational tools allow the user to proceed through the user interfaces described herein and include a select file control 604, a confirm data control 632, and a review control 634. Selection of the select file control 604 causes the presentation of the user interface depicted in FIG. 4 in which the user can select one or more of the corresponding images in a group of corresponding images. FIG. 7 depicts a user interface after the user has selected the confirm data control 632. Similarly, selection of back control 628 causes presentation of the user interface of FIG. 4 and selection of the next control 630 causes presentation of the user interface of FIG. 7.

FIG. 7 depicts a user interface 700 presenting data to be associated with one of the corresponding images, according to some embodiments. The user interface 700 includes a window 710. The window 710 includes the data that is to be associated with the selected corresponding image. The data that is to be associated with the selected corresponding image can include data that was originally associated with the corresponding image and any modifications to the data associated with the selected corresponding image. For example, if the user has added a date to be associated with the selected corresponding image (e.g., via the user interface depicted in FIG. 6), the added date will be included in the window 710.

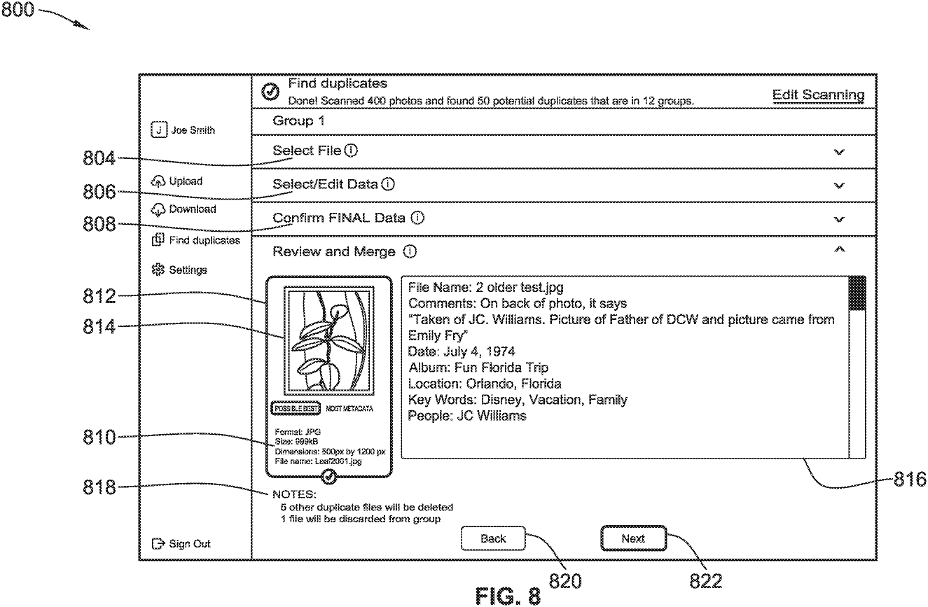

The user interface 700 includes navigational tools. The navigational tools allow the user to proceed through the user interface described herein and include a select file control 704, a select data control 706, and a review control 712. The select data control 706 causes presentation of the user interface of FIG. 6. The review control causes presentation of the user interface of FIG. 8. Similarly, selection of a back control 714 causes presentation of the user interface of FIG. 6 and selection of a next control 716 causes presentation of the user interface of FIG. 8.

FIG. 8 depicts a user interface 800 in which a user can review data to be merged and associated with a corresponding image, according to some embodiments. The corresponding image is the image that has been selected (e.g., by the user and/or the system). The user interface 800 includes a tile 812, a window 816, and a notes field 818. The tile 812 includes a representation 814 of the corresponding image (e.g., the corresponding image, a portion of the corresponding image, a thumbnail of the corresponding image, etc.) and information about the corresponding image 810. The window 816 includes the data to be associated with the corresponding image. The data that is to be associated with the selected corresponding image can include data that was originally associated with the corresponding image and any modifications to the data associated with the selected corresponding image. For example, if the user has added a date to be associated with the selected corresponding image (e.g., via the user interface depicted in FIG. 6), the added date will be included in the window 816. The notes field 818 includes information for the user regarding actions and/or results caused by the selection of the corresponding image and the merging of the data. For example, the notes field 818 can indicate that one or more of the corresponding images will be deleted (e.g., deleted from a database, removed from an album, hidden from view, etc.), discarded from a group, etc.

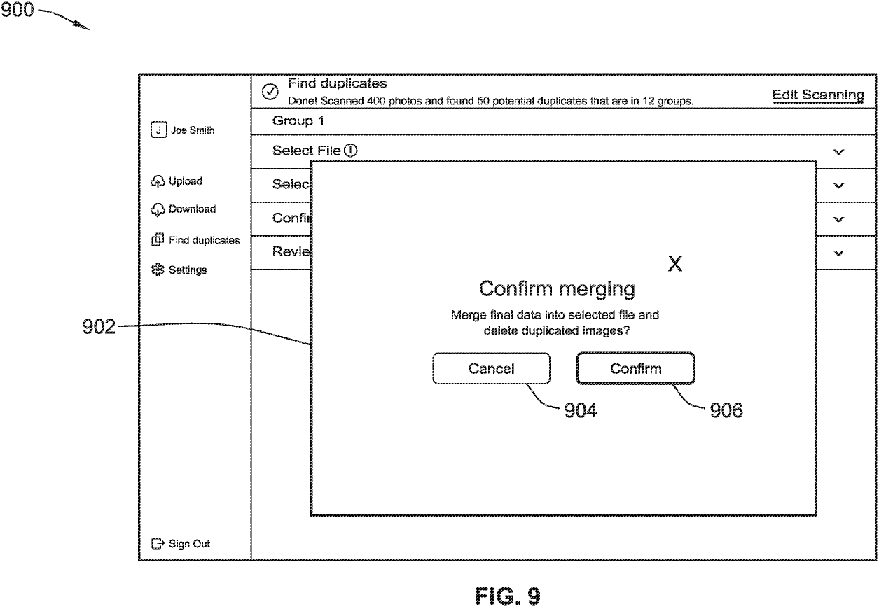

The user interface 800 includes navigational tools. The navigational tools allow the user to proceed through the user interface described herein and include a select file control 804, a select data control 806, and a confirm control 808. The confirm data control 808 causes presentation of the user interface of FIG. 7. Similarly, selection of a back control 820 causes presentation of the user interface of FIG. 7 and selection of a next control 822 causes presentation of the user interface of FIG. 9.

FIG. 9 depicts a user interface 900 in which a user can confirm merging of data associated with corresponding images. The user interface 900 includes a dialogue 902. The dialogue 902 prompts the user to confirm or cancel the merging of the data associated with the selected corresponding image. Additionally, the dialogue 902 can include information regarding actions and/or results caused by the selection of the corresponding image and the merging of the data. For example, as note din FIG. 9, if the user confirms the merging of the data, the data previously selected will be associated with the selected corresponding image and duplicate images will be deleted (e.g., deleted from a database, removed from an album, hidden from view, etc.). In some embodiments, the user interface 900 (or any of the other user interfaces described herein) can include an “undo” selection. In such embodiments, the user can select the “undo” selection to remove changes that have been made. For example, selection of the “undo” selection may revert the digital images back to their original state, undo the most recently performed action, etc.

While the discussion of FIGS. 1-9 provides an example of identifying corresponding images and user interfaces that allow a user to select what associated data they would like to retain from the corresponding images with respect to a single user’s files, embodiments are not so limited. For example, in some embodiments, the files can be stored in a shared library that is accessible by multiple people (e.g., a family group of friends, etc.). In such embodiments, a group of users may add (e.g., upload) files to a shared (e.g., cloud-based) library. Because multiple users are adding files to the shared library, more than one user may upload the same (or similar) files. The systems, methods, and apparatuses described herein allow the multiple users to manage the corresponding files and their associated data. For example, when an image is added to the shared library that corresponds to another image in the library, one or more of the multiple users can receive a prompt indicating that the images are corresponding images and to select what, if any, associated data for the corresponding images that they would like to merge and/or keep with a selected one of the corresponding images. The system can include an arbitration process if ones of the multiple users select differing ones of the associated data. For example, the system can alert users if differing ones of the associated data have been selected and ask the users to approve the selection. Further, in some embodiments, upon the identification of corresponding images in the shared library and selection of associated data to merge and/or keep, if one of the users has a corresponding image in another library (e.g., their personal library), the system can identify the corresponding image in the user’s other library and prompt the user to harmonize the data associated with the corresponding image in their other library with the shared library.

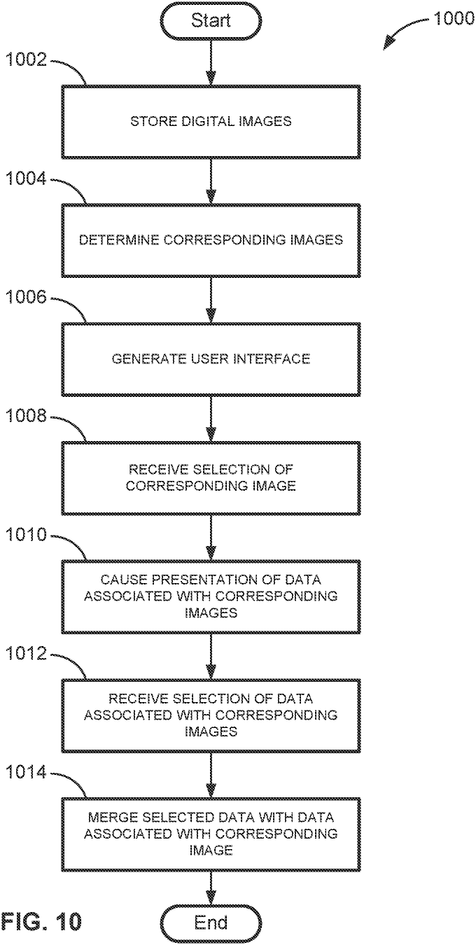

While the discussion of FIGS. 1 - 9 provides an overview of, including example user interfaces for, identifying corresponding images and selecting data to associate with one or more of the corresponding images, the discussion of FIG. 10 describes example operations for processing digital images.

FIG. 10 is a flow chart depicting example operations for processing digital images, according to some embodiments. The flow begins at block 1002.

At block 1002, digital images are stored. For example, a database can store the digital images. The database can be local to a user device (e.g., resident in memory of storage device) and/or located remotely from the user device (e.g., on an external drive, in local network storage (e.g., one a device connected via a local area network (LAN), in a cloud-based storage system, etc.). As one example, the database is remote from the user device and is accessible via a wide area network (WAN). The database stores the digital images as files. The files include the digital images (i.e., primary content) as well as data associated with the digital images. Though the discussion of FIG. 10 refers to digital images, it should be noted that the database can store any suitable type of digital content (e.g., videos, audio recordings, text files, spreadsheets, etc.). The flow continues at block 1004.

At block 1004, it is determined that a subset of the digital images are corresponding images. For example, a control system can determine that a subset of the digital images are corresponding images. Digital images are corresponding digital images in that they contain the same, or similar, primary content. For example, two digital images may be corresponding images if they are identical images, images created within a certain time of one another (e.g., images in a series of images taken in quick succession), images that contain a certain portion of matching features, etc. The control system determines that digital images are corresponding images based on a matching algorithm. The control system can utilize any suitable matching algorithm or technique for identifying corresponding images. For example, the control system can analyze data associated with the images (e.g., file names, metadata, creation dates, etc.), utilize checksums, analyze pixels in the images, analyze objects in the images, etc. With respect to the analysis of data associated with the images, the control system can, for example, compare file names of images (or other data associated with the images) to determine whether images are corresponding images. As one example, if two images have the same, or similar, file names, it may indicate that the images are corresponding images. With respect to checksums, the control system can utilize a hash function (e.g., a message digest algorithm such as MD5, SHA1, SHA256, etc.). Further, in some embodiments, the control system can perform a pixel analysis to identify corresponding images. For example, the control system can analyze pixels of various regions of the images to determine if, for example, the pixels have been duplicated. In some embodiments, the control system performs this analysis by matching blocks of image pixels and/or transform coefficients. Further, as other examples, the control system can identify corresponding imgaes via an analysis of objects in the digital images (e.g., buildings, landscape, people, etc.), an image recognition algorithm, an analysis of colors in the digital images (e.g., a color histogram), and an analysis of data associated with the digital images. Further, in some embodiments, the control system can identify duplicates based on a combination of the above-noted mechanisms. In some embodiments, the matching algorithm is based on a threshold. For example, only those digital images that satisfy the threshold with respect to matching are corresponding images. In such embodiments, the threshold may be automatically and/or manually adjusted. For example, the control system may automatically adjust the threshold during the identification of corresponding images. Additionally, or alternatively, a user may be able to manually adjust and/or modify the threshold based on the results of the matching algorithm (e.g., via a user-defined threshold). The control system can perform the matching algorithm automatically and/or in response to user input. For example, in some embodiments, the control system may perform the matching algorithm periodically an inform the user of any corresponding images. Additionally, or alternatively, the user may be able to manually initiate performance of the matching algorithm by the control system. The flow continues at block 1006.

At block 1006, a user interface is generated. For example, the control system generates the user interface. The user interface includes at least a portion of some, or all, of the corresponding digital images. For example, the user interface can include thumbnails associated with each of the corresponding images. The flow continues at block 1008.

At block 1008, a selection of one of the corresponding images is received. For example, the control system can receive the selection of the one of the corresponding images. In some embodiments, the control system receives the selection of the selected image from the user. For example, after reviewing the corresponding images, the user can select one of the corresponding images. Additionally, in some embodiments, the control system can recommend, or possible select, one of the corresponding images for the user. In such embodiments, the control system can recommend (or select) one of the corresponding images based on data associated with the corresponding images and/or an analysis of the primary content of the corresponding images. For example, the control system can recommend (or select) one of the corresponding images based on a resolution of the corresponding image, an amount of data associated with the corresponding image, the presence of one or more data entries for the data associated with the corresponding image, a file size of a file associated with the corresponding image, a clarity of the corresponding image, a date associated with the corresponding image, etc. The control system can present, via the user interface, an indication of the recommended (or selected) corresponding image and, in some embodiments, information indicating why the corresponding image was recommended (or selected). The flow continues at block 1010.

At block 1010, data associated with the corresponding images is presented. For example, the control system can present the data associated with the corresponding images via the user interface. The data associated with the corresponding images can include captions, dates, file names, locations, people, albums, keywords, file sizes, dimensions, resolutions, file types, etc. In some embodiments, the data associated with the corresponding images is presented simultaneously with the presentation of the corresponding images. For example, the user interface can include both the thumbnails of the corresponding images and the data associated with the corresponding images and an indication of which data are associated with each of the corresponding images. Alternatively, the user interface can include the data associated with the corresponding images after the selection of the one of the corresponding images. In such embodiments, the user interface can aggregate the data associated with the corresponding images. For example, if two of the corresponding images include dates, the user interface can present both of the dates associated with the corresponding images. Additionally, in some embodiments as described herein, the user can edit, add, modify etc. data for association with the corresponding image. The flow continues at block 1012.

At block 1012, a selection of data associated with the corresponding images is received. For example, the control system can receive the selection of data associated with the corresponding images from the user. As previously discussed, the corresponding images may include the same, or similar, primary content but include different associated data. Continuing the previous example, assume that two digital images (i.e., Photo₁ and Photo₂) are corresponding images and that Photo₁ includes a location tag (i.e., Photo₁ has data associated with it that indicates a location associated with Photo₁) and Photo₂ includes a date tag (i.e., Photo₂ has data associated with that indicated a date associated with Photo₂). If the user (or control system) has selected Photo₂ as the selected corresponding image, the user could choose to merge the location tag from Photo₁ into the data file associated with Photo₂ such that Photo₂ includes both the location tag and the date tag. The user would then be able to remove Photo₁ while still maintaining the data associated with Photo₁ as data associated with Photo₂. In this manner, the user can select data associated with one or more of the corresponding images to merge with the data associated with the selected corresponding image. The user can select the data associated with the corresponding images via selection of data fields, selection of one or more of the corresponding images (e.g., selection of a corresponding image indicates that the data associated with that corresponding image should be merged with the data associated with the selected corresponding image), etc. Additionally, in some embodiments, the control system can recommend, or select, data to merge with the associated corresponding image. The control system can recommend and/or select the data to merge based on any suitable criterion. For example, the control system could automatically attempt to populate every data field by selecting data associated with each of the corresponding images best suited to accomplish this task. As another example, the control system could select the data for each data field that is the richest (e.g., most detailed, longest, most complete, etc.). The flow continues at block 1014.

At block 1014, the selected data is merged with the data associated with the corresponding image. For example, the control system can merge the selected data with the data associated with the selected corresponding image. The control system can merge the selected data automatically and/or based on user input. For example, in one embodiment, the control system presents a user interface indicating the data to be merged and changes to the data that will result from merging the data. In some embodiments, the corresponding images and data associated with the corresponding images that is not selected is discarded. For example, referring back to the example of Photo₁ and Photo₂, if Photo₂ is the selected image, the control system can discard Photo₁ and any data associated with Photo₁ (and possibly Photo₂) that was not selected. The control system can discard the non-selected corresponding images and data by deleting the non-selected corresponding images and/or data, archiving the non-selected corresponding images and/or data, removing the non-selected corresponding images and/or data from an album, etc.

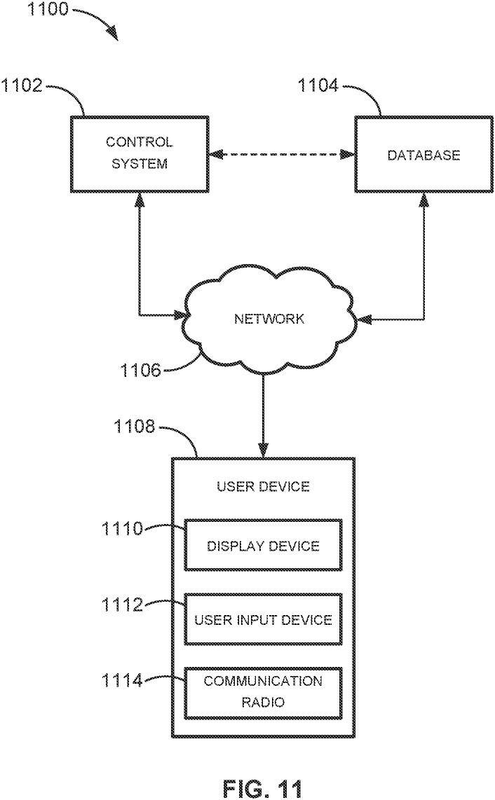

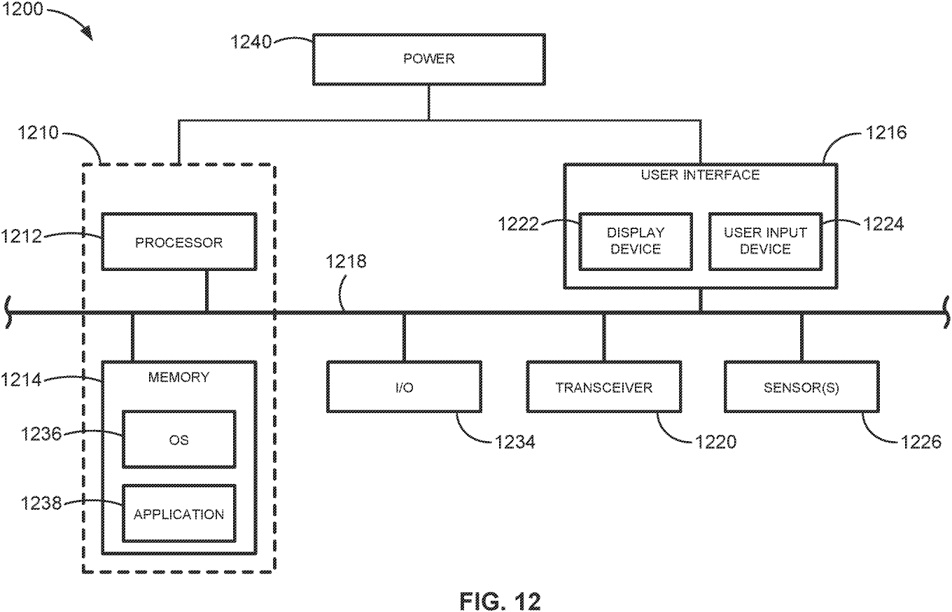

While the discussion of FIG. 10 describes example operations for processing digital images, the discussion of FIGS. 11 and 12 provides additional detail regarding a system for processing digital images.

FIG. 11 is a block diagram of a system 1100 for processing digital images, according to some embodiments. The system 1100 includes a control system 1102, a database 1104, a network 1106, and a user device 1108. One or more of the control system 1102, the database 1104, and the user device 1108 are communicatively coupled via the network 1106. The network 1106 can be of any suitable type and include wired and/or wireless links. For example, the network 1106 can be a LAN and/or WAN (e.g., such as the Internet).

The database 1104 stores digital content. For example, the database 1104 can store files associated with digital images, digital videos, digital audio recordings, or any other suitable type of digital content. Though depicted as remote from the user device 1108, the database 1108 can be resident on the user device 1108.

The user device 1108 includes a display device 1110, a user input device 1112, and a communication radio 1114 and can be of any suitable type. For example, the user device can be a mobile device (e.g., a smartphone), a tablet computer, a personal digital assistant (PDA), a desktop computer, a laptop computer, etc. In some embodiments, the display device 1110 and the user input device 1112 can be incorporated into a single device, such as a touchscreen. The user device presents information to a user (e.g., via the display device 1110) and receives commands from the user (e.g., via the user input device 1112). For example, the display device 1110 can present digital content to the user and user interfaces associated with the processing of the digital content. The user input device 1112 can receive commands to, for example, process the digital content. The communication radio 1114 is configured to transmit data to, and receive data from, one or more of the control system 1102 and the database 1104.

The control system 1102 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control system 1102 is configured (for example, by using corresponding programming as will be well understood by those skilled in the art) to carry out one or more of the steps, actions, and/or functions described herein.

By one optional approach the control system 1102 operably couples to a memory. The memory may be integral to the control system 1102 or can be physically discrete (in whole or in part) from the control system 1102 as desired. This memory can also be local with respect to the control system 1102 (where, for example, both share a common circuit board, chassis, power supply, and/or housing) or can be partially or wholly remote with respect to the control system 1102 (where, for example, the memory is physically located in another facility, metropolitan area, or even country as compared to the control system 1102).

This memory can serve, for example, to non-transitorily store the computer instructions that, when executed by the control system 1102, cause the control system 1102 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control system 1102 is performs operations for the processing of digital images. Specifically, in one embodiment, the control system 1102 identifies corresponding images, allows the user to select one of the corresponding images, and allows the user to select data from the corresponding images to merge with the selected corresponding image. Such processing of the digital images can reduce the clutter caused by duplicate images while maintaining data associated with the duplicate images.

In one embodiment, the control system 1102 performs a matching algorithm to identify digital images that are corresponding images. For example, the control system 1102 performs the matching algorithm on data files that are associated with the digital content in the database 1104. The corresponding images are those images that have the same, or similar, primary content. For example, two images may be corresponding images if they are identical images, images created within a certain time of one another (e.g., images in a series of images taken in quick succession), images that contain a certain portion of matching features, etc. The data files include data in addition to the images. That is, the data files include data associated with the digital images. The data associated with the digital images can include captions, dates, file names, locations, people, albums, keywords, etc. The data associated with the digital images may not be the same for each of the corresponding images. Accordingly, though the images are corresponding images, the data files may not correspond with one another. The matching algorithm can be of any suitable type. For example, the matching algorithm can be a hash function (e.g., a message digest algorithm such as MD5), an analysis of objects in the digital images (e.g., buildings, landscape, people, etc.), image recognition algorithm, an analysis of colors in the digital images (e.g., a color histogram), and an analysis of data associated with the digital images.

The control system 1102 aggregates the data associated with the corresponding images and presents a user interface(s) that includes the corresponding images (e.g., the corresponding images, thumbnails of the corresponding images, portions of the corresponding images, etc.) and the data associated with the corresponding images. The user device 1108 presents the user interface(s) and the user can select from amongst the corresponding images one or more of the corresponding images to keep. The user can also select which of the data associated with the corresponding images to keep. The control system 1102 merges the selected data with the data associated with the selected corresponding image. The control system 1102 can merge the data by replacing existing data or aggregating the data. For example, if the selected corresponding image includes a first date tag and the user selects a second date tag from one of the non-selected corresponding images, the system can replace the first date tag with the second date tag. Alternatively, continuing this example, the control system 1102 can merge the data associated with the selected image by adding the second date tag to the selected corresponding image while retaining the first date tag.

In some embodiments, the control system 1102 can recommend, or select, one of the corresponding images as a recommended corresponding image and/or one or more of the data associated with the corresponding images. For example, the control system 1104 can select the recommended image based on resolution, size, file format, inclusion of data, an amount of data, clarity, etc.

After the data has been merged, in some embodiments, the control system 1102 can cause removal of the non-selected corresponding images and/or the non-selected data associated with the corresponding images. For example, the control system can cause such removal by deleting one or more data files from the database 1104, removing the non-selected corresponding images from an album, archiving the non-selected digital images, preventing the non-selected corresponding images from being presented, generating pointers from the selected corresponding image to the non-selected corresponding images for later retrieval, etc.

FIG. 12 is a block diagram of a system 1200 that may be used for implementing any of the components, circuits, circuitry, systems, functionality, apparatuses, processes, or devices of the system of FIG. 11, and/or other above or below mentioned systems or devices, or parts of such circuits, circuitry, functionality, systems, apparatuses, processes, or devices, according to some embodiments. The circuits, circuitry, systems, devices, processes, methods, techniques, functionality, services, servers, sources and the like described herein may be utilized, implemented and/or run on many different types of devices and/or systems. For example, the system 1200 may be used to implement some or all of the control system, the database, the user device, and/or other such components, circuitry, functionality and/or devices. However, the use of the system 1200 or any portion thereof is not required.

By way of example, the system 1200 may comprise a processor (e.g., a control system) 1212, memory 1214, and one or more communication links, paths, buses or the like 1218. Some embodiments may include one or more user interfaces 1216, and/or one or more internal and/or external power sources or supplies 1240. The processor 1212 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 1212 can be part of a control circuit 1210, which may be implemented through one or more processors with access to one or more memory 1214 that can store commands, instructions, code and the like that is implemented by the control system and/or processors to implement intended functionality. In some applications, the control system and/or memory may be distributed over a communications network (e.g., LAN, WAN, the Internet) providing distributed and/or redundant processing and functionality. Again, the system 1200 may be used to implement one or more of the above or below, or parts of, components, circuits, systems, processes and the like.

In one embodiment, the memory 1214 stores data and executable code, such as an operating system 1236 and an application 1238. The application 1238 is configured to be executed by the system 1200 (e.g., by the processor 1212). The application 1238 can be a dedicated application (e.g., an application dedicated to processing digital images) and/or a general purpose application (e.g., a web browser, digital content management application, a digital content viewer, etc.). Additionally, though only a single instance of the application 1238 is depicted in FIG. 12, such is not required and the single instance of the application 1238 is shown in an effort not to obfuscate the figures. Accordingly, the application 1238 is representative of all types of applications resident on the user device (e.g., software preinstalled by the manufacturer of the user device, software installed by an end user, etc.). In one embodiment, the application 1238 operates in concert with the operating system 1236 when executed by the processor 1212 to cause actions to be performed by the user device 1200. For example, with respect to the disclosure contained herein, execution of the application 1238 by the processor 1212 causes the user device to perform actions consistent with the processing of digital images as described herein.

The user interface 1216 can allow a user to interact with the system 1200 and receive information through the system. In some instances, the user interface 1216 includes a display device 1222 and/or one or more user input device 1224, such as buttons, touch screen, track ball, keyboard, mouse, etc., which can be part of or wired or wirelessly coupled with the system 1200. Typically, the system 1200 further includes one or more communication interfaces, ports, transceivers 1220 and the like allowing the system 1200 to communicate over a communication bus, a distributed computer and/or communication network (e.g., a local area network (LAN), wide area network (WAN) such as the Internet, etc.), communication link 1218, other networks or communication channels with other devices and/or other such communications or combination of two or more of such communication methods. Further the transceiver 1220 can be configured for wired, wireless, optical, fiber optical cable, satellite, or other such communication configurations or combinations of two or more of such communications. Some embodiments include one or more input/output (I/O) ports 1234 that allow one or more devices to couple with the system 1200. The I/O ports can be substantially any relevant port or combinations of ports, such as but not limited to USB, Ethernet, or other such ports. The I/O interface 1234 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1226 to provide information to the system and/or sensor information that is communicated to another component, such as the central control system, a delivery vehicle, etc. The sensors 1226 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The system 1200 comprises an example of a control and/or processor-based system with the processor 1212. Again, the processor 1212 can be implemented through one or more processors, controllers, central processing units, logic, software and the like. Further, in some implementations the processor 1212 may provide multiprocessor functionality.

The memory 1214, which can be accessed by the processor 1212, typically includes one or more processor-readable and/or computer-readable media accessed by at least the control system, and can include volatile and/or nonvolatile media, such as RAM, ROM, EEPROM, flash memory and/or other memory technology. Further, the memory 1214 is shown as internal to the control system 1210; however, the memory 1214 can be internal, external or a combination of internal and external memory. Similarly, some, or all, of the memory 1214 can be internal, external or a combination of internal and external memory of the processor 1212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network. The memory 1214 can store code, software, executables, scripts, data, content, lists, programming, programs, log or history data, user information, customer information, product information, and the like. While FIG. 12 illustrates the various components being coupled together via a bus, it is understood that the various components may actually be coupled to the control system and/or one or more other components directly.

In some embodiments, a system for processing digital images comprises a database configured to store a plurality of digital images and a control system configured to determine, using a matching algorithm, that a subset of the plurality of digital images are corresponding images, generate a user interface including at least a portion of one or more of the corresponding images, receive, from a user via the user interface, a selection associated with one of the corresponding images, cause data associated with one or more of the corresponding images to be presented via the user interface, receive, from the user via the user interface, a selection of at least a portion of the data associated with one or more of the corresponding images, and responsive to the selection of at least a portion of the data associated with one or more of the corresponding images, merge the at least a portion of the data associated with one or more of the corresponding images with data associated with the one of the corresponding images.

In some embodiments, an apparatus and a corresponding method performed by the apparatus comprises storing, in a database, a plurality of digital images, determining, by a control system using a matching algorithm, that a subset of the plurality of digital images are corresponding digital images, generating, by the control system, a user interface including at least a portion of one or more of the corresponding images, receiving, by the control system via the user interface, a selection of one of the corresponding images, causing, by the control system, presentation of data associated with one or more of the corresponding images, receiving, by the control system via the user interface, a selection of at least a portion of the data associated with one or more of the corresponding images, and responsive to the selection of at least a portion of the data associated with one or more of the corresponding images, merging, by the control system, the at least a portion of the data associated with one or more of the corresponding images with data associated with the one of the corresponding images.

In some embodiments, one or more non-transitory computer-readable storage devices including instructions to, when executed by one or more processors, cause the one or more processors to perform operations comprising storing, in a database, a plurality of digital images, determining, using a matching algorithm, that a subset of the plurality of digital images are corresponding images, generating a user interface including at least a portion of one or more of the corresponding images, receiving, from a user via the user interface, a selection of one of the corresponding images, causing presentation, via the user interface, of data associated with one or more of the corresponding images, receiving, from the user via the user interface, a selection of at least a portion of the data associated with one or more of the corresponding images, and responsive to the selection of at least a portion of the data associated with one or more of the corresponding images, merging the at least a portion of the data associated with one or more of the corresponding images with data associated with the one of the corresponding images.

In some embodiments, a system for processing digital images comprises a database configured to store a plurality of digital images and a control system configured to determine, based on a matching algorithm, that a first image and a second image of the plurality of digital images are corresponding images, generate a user interface including at least a portion of the first image and at least a portion of the second image, receive, from a user via the user interface, a selection associated with the first image, cause data associated with the first image and data associated with the second image to be presented via the user interface, receive, from the user via the user interface, a selection of at least a portion of the data associated with the second image, and responsive to the selection of at least a portion of the data associated with the second image, merge the at least a portion of the data associated with the second image with the data associated with the first image.

In some embodiments, a system for processing digital images comprises a database configured to store a plurality of digital images and a control system configured to determine, based on a matching algorithm, that a first image and a second image of the plurality of digital images are corresponding images, recommend, based on data associated with the first image and data associated with the second image, the first image, cause the data associated with the second image to be presented via the user interface, receive, from the user via the user interface, a selection of at least a portion of the data associated with the second image, and responsive to the selection of at least a portion of the data associated with the second image, merge the at least a portion of the data associated with the second image with the data associated with the first image.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

What is claimed is:

1. A system for processing digital images, the system comprising:
a database configured to store a plurality of digital images; and
a control system configured to:
determine, using a matching algorithm, that a subset of the plurality of digital images are corresponding images;
generate a user interface including at least a portion of one or more of the corresponding images;
receive, from a user via the user interface, a selection associated with one of the corresponding images;
cause data associated with one or more of the corresponding images to be presented via the user interface;
receive, from the user via the user interface, a selection of at least a portion of the data associated with one or more of the corresponding images; and
responsive to the selection of at least a portion of the data associated with one or more of the corresponding images, merge the at least a portion of the data associated with one or more of the corresponding images with data associated with the one of the corresponding images.

2. The system of claim 1, wherein the matching algorithm is based on a hash function, a pixel analysis, a checksum analysis, an analysis of objects in the plurality of digital images, image recognition, colors present in the plurality of digital images, data associated with the plurality of images, or any combination thereof.

3. The system of claim 1, wherein the selection of at least a portion of the data associated with one or more of the corresponding images includes one or more of an indication of fields of data and an image of the corresponding images.

4. The system of claim 1, wherein the control system is further configured to:
select, based on the data associated with the one or more of the corresponding images, a recommended image.

5. The system of claim 4, wherein the recommended image is selected based on one or more of a resolution, a size, a file format, an inclusion of data, an amount of data, and a clarity.

6. The system of claim 1, wherein the matching algorithm is based on a threshold.

7. The system of claim 6, wherein the user interface includes a threshold selection with which the user can define the threshold.

8. The system of claim 1, wherein the matching algorithm is performed one of automatically and in response to a received user request.

9. The system of claim 1, wherein the user interface includes a plurality of selections, wherein each of the selections corresponds to the data associated with one or more of the corresponding images.

10. The system of claim 9, wherein the selections are populated based on the data associated with one or more of the one of the corresponding images.

11. The system of claim 1, wherein the user interface includes one or more data entry selections that allow the user to enter data for association with the one of the corresponding images.

12. The system of claim 1, wherein the control system is further configured to:
select, from the data associated with one or more of the corresponding images, recommended data.

13. The system of claim 1, wherein the user interface includes a file format selection, wherein the file format selection allows the user to select a file format for saving the one of the corresponding images.

14. The system of claim 1, wherein the control system is further configured to:
cause removal, in response to the merging, of at least some of the corresponding images from the database.

15. The system of claim 1, wherein the at least a portion of one or more of the corresponding images and the at least a portion of the data associated with one or more of the corresponding images are presented simultaneously via the user interface.

16. A method for processing digital images, the method comprising:
storing, in a database, a plurality of digital images;
determining, by a control system using a matching algorithm, that a subset of the plurality of digital images are corresponding digital images;
generating, by the control system, a user interface including at least a portion of one or more of the corresponding images;
receiving, by the control system via the user interface, a selection of one of the corresponding images;
causing, by the control system, presentation of data associated with one or more of the corresponding images;
receiving, by the control system via the user interface, a selection of at least a portion of the data associated with one or more of the corresponding images; and
responsive to the selection of at least a portion of the data associated with one or more of the corresponding images, merging, by the control system, the at least a portion of the data associated with one or more of the corresponding images with data associated with the one of the corresponding images.

17. The method of claim 16, wherein the matching algorithm is based on a hash function, a pixel analysis, a checksum analysis, an analysis of objects in the plurality of digital images, image recognition, colors present in the plurality of digital images, data associated with the plurality of images, or any combination thereof.

18. The method of claim 16, wherein the user interface includes a plurality of selections, wherein each of the selections corresponds to the data associated with one or more of the corresponding images.

19. The method of claim 16, wherein the user interface includes one or more data entry selections that allow the user to enter data for association with the one of the corresponding images.

20. One or more non-transitory computer-readable storage devices including instructions to, when executed by one or more processors, cause the one or more processors to perform operations comprising:
storing, in a database, a plurality of digital images;
determining, using a matching algorithm, that a subset of the plurality of digital images are corresponding images;
generating a user interface including at least a portion of one or more of the corresponding images;
receiving, from a user via the user interface, a selection of one of the corresponding images;
causing presentation, via the user interface, of data associated with one or more of the corresponding images;
receiving, from the user via the user interface, a selection of at least a portion of the data associated with one or more of the corresponding images; and
responsive to the selection of at least a portion of the data associated with one or more of the corresponding images, merging the at least a portion of the data associated with one or more of the corresponding images with data associated with the one of the corresponding images.

21. The one or more non-transitory computer-readable storage devices of claim 20, wherein the user interface includes a plurality of selections, wherein each of the selections corresponds to the data associated with one or more of the corresponding images.

22. The one or more non-transitory computer-readable storage devices of claim 20, wherein the user interface includes one or more data entry selections that allow the user to enter data for association with the one of the corresponding images.

23. A system for processing digital images, the system comprising:
a database configured to store a plurality of digital images; and
a control system configured to:
determine, based on a matching algorithm, that a first image and a second image of the plurality of digital images are corresponding images;
generate a user interface including at least a portion of the first image and at least a portion of the second image;
receive, from a user via the user interface, a selection associated with the first image;
cause data associated with the first image and data associated with the second image to be presented via the user interface;
receive, from the user via the user interface, a selection of at least a portion of the data associated with the second image; and
responsive to the selection of at least a portion of the data associated with the second image, merge the at least a portion of the data associated with the second image with the data associated with the first image.

24. A system for processing digital images, the system comprising:
a database configured to store a plurality of digital images; and
a control system configured to:
determine, based on a matching algorithm, that a first image and a second image of the plurality of digital images are corresponding images;
recommend, based on data associated with the first image and data associated with the second image, the first image;
cause the data associated with the second image to be presented via the user interface;
receive, from the user via the user interface, a selection of at least a portion of the data associated with the second image; and
responsive to the selection of at least a portion of the data associated with the second image, merge the at least a portion of the data associated with the second image with the data associated with the first image.

25. The system of claim 23, wherein the control system is further configured to:
cause the data associated with first image to be presented via the user interface;
receive, from the user via the user interface, a selection of at least a portion of the data associated with the first image; and
responsive to the selection of at least a portion of the data associated with the first image, disassociate the at least a portion of the data associated with the first image from the first image.
